(19) United States
(12) Patent Application Publication
(10) Pub. No.: US 2018/0072026 A1
(43) Pub. Date: Mar. 15, 2018

(54) THERMOFORMED SOUND PROTECTION ELEMENT FOR A MOTOR VEHICLE

(71) Applicant: CERA APS, Reims (FR)

(72) Inventors: Dominique Lemaire, Villiers devant le Thour (FR); Guillaume Crignon, Sillery (FR); Christophe Capron, Epoye (FR)

(21) Appl. No.: 15/559,068

(22) PCT Filed: Mar. 10, 2016
(86) PCT No.: PCT/FR2016/050542

§ 371 Date: Sep. 18, 2017

(30) Foreign Application Priority Data
Mar. 19, 2015 (FR) 1552280

(51) Int. Cl. B32B 27/12; B32B 3/26; B32B 1/00; B32B 5/02; B32B 7/02; B32B 27/30; B32B 27/06; B32B 27/28; B32B 5/26; B32B 7/10; B32B 5/14; B60R 13/08

(52) U.S. Cl. CPC B32B 27/12; B32B 2307/10; B32B 1/00; B32B 5/02; B32B 5/022; B32B 7/02; B32B 27/304; B32B 27/06; B32B 27/28; B32B 5/26; B32B 7/10; B32B 5/14; B60R 13/08; B32B 2605/08; B32B 2305/18; B32B 2307/56; B32B 2262/02; B32B 2605/003; B32B 2307/102; B32B 3/26

(57) ABSTRACT

A thermoformed element in the form of a sound attenuation panel or of a lateral boot lining for sound protection for a motor vehicle, the element comprising two porous fibrous layers including a face layer and a back layer, the porous fibrous layers consisting of a carpet, a felt and a non-woven fabric, the thermoformed element comprising a heavy area of high sound protection comprising a first intermediate layer made from crushed recycled material arranged between the two porous fibrous layers, at least one light area of low sound protection comprising a second intermediate layer made from crushed recycled material arranged between the two porous fibrous layers, the second intermediate layer having a mass per unit area less than the first intermediate layer, forming a first type of light area, the two porous fibrous layers being arranged in contact with each other to form a second type of light area.

### BACKGROUND

The invention relates to a thermoformed sound protection element for a motor vehicle and a method for producing such an element.

It is known to produce a thermoformed element—for example in the form of a sound attenuation of a panel or of a lateral boot lining—for the sound protection for a motor vehicle, said element comprising two porous fibrous layers between which is arranged an intermediate layer made from crushed recycled material.

It is in particular known to produce the intermediate layer made from crushed recycled material, in particular of the plastic film, carpet, etc. type.

The layer of crushed material, deposited via sprinkling, has a substantially uniform mass per unit area, knowing the element is generally arranged facing a heterogeneous sound emission surface.

In order to provide adequate sound protection, it is necessary to arrange a quantity of crushed material that takes into account the portion of the most emissive surface.

This results in obtaining an element of substantial mass that contributes to increasing the weight of the vehicle, which is detrimental in terms of fuel consumption.

The purpose of the invention is to overcome this disadvantage.

### SUMMARY

To this effect, and according to a first aspect, the invention proposes a thermoformed element—in particular in the form of a sound attenuation of a panel or of a lateral boot lining—for the sound protection for a motor vehicle, said element comprising two porous fibrous face and back layers—in particular in the form of carpet, felt or non-woven fabric—, said element having, in front view:
a heavy area, of high sound protection, comprising a first intermediate layer made from crushed recycled material arranged between said fibrous layers,
at least one light area, of low sound protection, said light area:
comprising a second intermediate layer made from crushed recycled material arranged between said fibrous layers, said second layer having a mass per unit area less than that of said first layer, so as to form a first type of light area,
or indeed having no intermediate layer, said fibrous layers being arranged in contact with each other, so as to form a second type of light area.

The arrangement proposed makes it possible to place on each area of the element only what is strictly necessary as an intermediate layer, even to not place any intermediate layer, this according to the variations in sound emissivity of the surface of which it is desired to obtain sound protection, which makes it possible to produce light elements in relation to those known in prior art.

According to a second aspect, the invention proposes a method for producing such an element.

### BRIEF DESCRIPTION OF THE DRAWINGS

Other particularities and advantages of the invention shall appear in the description that follows, given in reference to the attached figures, wherein:

FIG. 1 is a partial cross-section diagrammatical view—according to the line AA of FIG. 2—of an element according to an embodiment,

FIG. 2 is a diagrammatical front view of the element of FIG. 1.

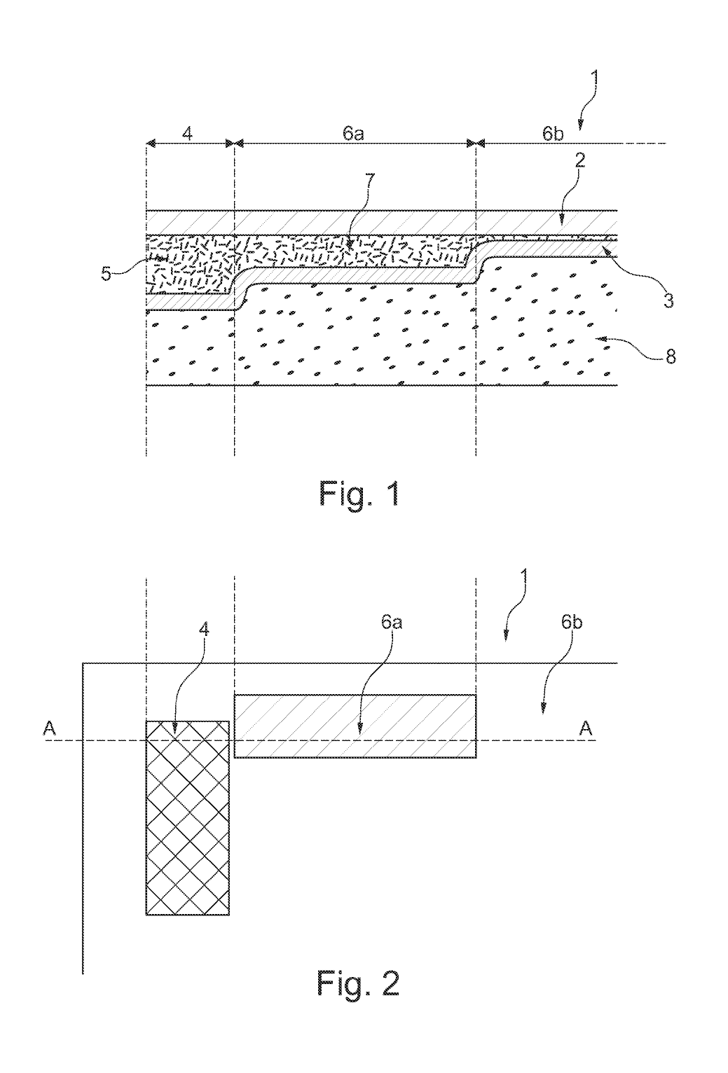

### DETAILED DESCRIPTION

In reference to the figures, a thermoformed element 1—in particular in the form of a sound attenuation of a panel or of a lateral boot lining—for the sound protection for a motor vehicle is described, said element comprising two porous fibrous face 2 and back 3 layers—in particular in the form of carpet, felt or non-woven fabric—, said element having, in front view:
a heavy area 4, of high sound protection, comprising a first intermediate layer 5 made from crushed recycled material arranged between said fibrous layers,
at least one light area 6a, 6b of low sound protection, said light area:
comprising a second intermediate layer 7 made from crushed recycled material arranged between said fibrous layers, said second layer having a mass per unit area less than that of said first layer, so as to form a first type of light area 6a,
or indeed having no intermediate layer, said fibrous layers being arranged in contact with each other, so as to form a second type of light area 6b.

According to the embodiment shown, the element 1 comprises a heavy area 4, at least one first type of light area 6a and at least one second type of light area 6b.

According to an embodiment, the first layer 5 has a resistance to the passage of air, measured according to the standard ISO 9053/method B by alternating flow of air, greater than 4000 N.s.m⁻³ in such a way as to have a seal that allows for sound insulation.

According to an embodiment, the element 1 further comprises, when the first layer 5 is sealed, an external layer 8—in particular made from foam or felt—elastically compressible arranged under the fibrous back layer 3, at least facing the heavy area 4, in such a way that said element forms an acoustic insulation complex of the “mass-spring” type.

According to an alternative one of the fibrous layers 2, 3 is itself elastically compressible in such a way as to play the role of a spring in a “mass-spring” system.

According to an embodiment, the first layer 5 comprises high-density waste made from thermoplastic elastomer—in particular of the ethylene-propylene-diene monomer type—, loaded with a mineral filler.

Its mass per unit area is for example between 1000 and 2000 g/m².

According to an embodiment, the second layer 7 comprises low-density waste made from fibres.

Its mass per unit area is for example between 100 and 500 g/m².

According to an embodiment, the fibrous layers 2, 3 are co-needled in such a way as to provide the cohesion of the various layers 2, 3, 5, 7.

According to an embodiment, at least one intermediate layer 5, 7 is made from polyvinyl butyral (PVB).

A conventional use of PVB consists in inserting it as a film between two layers of glass, in particular to produce windscreens of motor vehicles or windows of buildings.

A characteristic of this material is its very high elasticity which makes it possible to retain the broken glass and which prevents layers of glass from shattering during an impact.

Such an elasticity makes it possible to consider its thermoforming with substantial stretching, without ruptures that harm the seal that is sought for the intermediate layer 5, 7.

Furthermore, PVB has the particularity of having a density of about 1.1, much greater than that of the crushed material used in prior art, which makes it possible to arrange an intermediate layer 5, 7 of much lesser volume than that which is known in prior art, and therefore to optimise the available volume moreover in the vehicle.

Finally, PVB makes it possible to prevent a co-needling, this due to its highly sticky nature which can suffice to provide the connection of the fibrous layers 2, 3 between them.

A method of producing an element 1 is finally described, said method comprising the following steps:
providing at least one crushed recycled material,
providing two rolls of a fibrous layer 2, 3,
arranging said at least one crushed material by sprinkling on one of said rolls actuated in unwinding, in such a way as to produce light areas 6a, 6b and heavy areas 4, and covering the sprinkling with the other of said rolls actuated in unwinding,
cutting a blank in the complex obtained,
thermoforming said blank with the geometry of the element 1 to be obtained.

The thermoforming can be followed by a peripheral and/or internal cutting for a possible finishing.

A co-needling of the complex obtained before cutting the blank can be carried out, in order to provide cohesion between the porous layers 2, 3.

In the case of two intermediate layers 5, 7, two sprinklers can be provided, each provided with a crushed material, with their use being alternated over time or their positioning being offset, in such a way as to produce a light sprinkling in the first type of light area 6a and a heavy sprinkling in the heavy area 4.

Lapses of time can also be provided where no sprinkling is carried out, or a roll strip arranged at a distance from the sprinkler, in such a way as to produce a second type of light area 6b with no intermediate layer.

1. A thermoformed element in the form sound attenuation of a panel or of a lateral boot lining—for sound protection for a motor vehicle, said element comprising:
two porous fibrous layers including a face layer and a back layer, said porous fibrous layers selected from the group consisting of a carpet, a felt and a non-woven fabric, said thermoformed element comprising:
a heavy area of high sound protection comprising a first intermediate layer made from crushed recycled material arranged between said two porous fibrous layers,
at least one light area of low sound protection, said at least one light area
comprising a second intermediate layer made from crushed recycled material arranged between said two porous fibrous layers, said second intermediate layer having a mass per unit area less than that of said first intermediate layer, so as to form a first type of light area
said two porous fibrous layers being arranged in contact with each other, so as to form a second type of light area.

2. The element according to claim 1, wherein the first layer has a resistance to the passage of air, measured according to the standard ISO 9053/method B by alternating flow of air, greater than 4000 N.s.m⁻³ configured as a sound insulation seal.

3. The element according to claim 2, wherein said thermoformed element further comprises an external layer made from elastically compressible foam or felt arranged under the fibrous back layer, at least facing the heavy area, in such a way that said thermoformed element forms an acoustic insulation complex of a mass-spring type.

4. The element according to claim 3, wherein the first layer comprises a high-density waste made from thermoplastic elastomer of the ethylene-propylene-diene monomer type loaded with a mineral filler.

5. The element according to claim 4, wherein the second layer comprises low-density waste made from fibres.

6. The element according to claim 5, wherein the two porous fibrous layers are co-needled to provide the cohesion of the various layers.

7. The element according to claim 6, wherein at least one intermediate layer is made from polyvinyl butyral (PVB).

8. A method for producing the element according to claim 1, the method comprising the following steps:
providing at least one crushed recycled material,
providing two rolls of a fibrous layer,
arranging said at least one crushed recycled material by sprinkling on one of said two rolls actuated in unwinding, in such a way as to produce light areas and heavy areas, and covering the sprinkled at least one crushed recycled material with the other of said rolls actuated in unwinding,
cutting a blank from said two rolls,
thermoforming said blank to the geometry of the element to be obtained.
